(19) United States
(12) Patent Application Publication
(10) Pub. No.: US 2013/0295503 A1
(43) Pub. Date: Nov. 7, 2013

(54) METHOD FOR MANUFACTURING TONER

(71) Applicants: Dong Won Kim, Daejeon (KR); Sung Yul Kim, Daejeon (KR); Jin Young Kim, Daejeon (KR); Bo Young Kim, Seoul (KR); Moo Eon Park, Seoul (KR); Sung Soon Kim, Gwangmyeong-si (KR)

(72) Inventors: Dong Won Kim, Daejeon (KR); Sung Yul Kim, Daejeon (KR); Jin Young Kim, Daejeon (KR); Bo Young Kim, Seoul (KR); Moo Eon Park, Seoul (KR); Sung Soon Kim, Gwangmyeong-si (KR)

(73) Assignee: SAMSUNG FINE CHEMICALS CO., LTD., Ulsan (KR)

(21) Appl. No.: 13/997,429

(22) PCT Filed: Dec. 21, 2011
(86) PCT No.: PCT/KR2011/009942

§ 371 Date: Jun. 24, 2013

(30) Foreign Application Priority Data
Dec. 24, 2010 (KR) 10-2010-0134755

(51) Int. Cl. G03G 9/087

(52) U.S. Cl. CPC G03G 9/08755
USPC 430/137.14

(57) ABSTRACT

Disclosed is a method for manufacturing toner. The method for manufacturing toner according to the present invention uses specific polyester resin to obtain toner with a wide range of fixing temperatures and superior gloss and density of image.

### TECHNICAL FIELD

The present invention relates to a method for manufacturing toner, and more particularly, to a method for manufacturing toner having excellent preservability, fixability, and gloss.

### BACKGROUND ART

In general, toner is prepared by adding a colorant, a release agent, a charge controller, or the like to a thermoplastic resin that functions as a binder resin. Also, inorganic metal fine powder, such as silica or titanium oxide, may be added as an external additive to toner in order to provide fluidity to the toner or improve physical properties such as charge controlling or washing of toner. A method of preparing such a toner is classified into a physical method, such as a pulverization or the like, and a chemical method, such as a suspension polymerization method, an emulsion aggregation, method or the like.

Since a method of preparing toner by polymerization among the above chemical methods accompanies radical polymerization, only a vinyl-based resin may be used as a binder resin. However, in this case, since the polymerization may be difficult to be completely terminated, an non-reacted monomer, a surfactant, or the like may remain in toner particles, and thus, charge characteristics of the toner particles may be degraded.

Since a polyester resin may have advantages, such as improved pigment dispersibility, excellent transparency, low fixing temperature, and a narrow range of glass transition temperatures, in comparison to a vinyl-based resin such as a styrene-acryl-based copolymer resin, the polyester resin may be suitable for a binder resin of toner for a high-speed printer or a color printer.

A method of preparing toner using a polyester resin as a binder resin may include a method of preparing toner particles, in which toner particles are aggregated by using polyaluminum chloride (PAC) as a agglomerating agent in a mixed solution of a polyester resin dispersion, a colorant dispersion, and a wax dispersion, and the toner particles are then prepared through a freezing/fusing process. In the case that PAC is used as a agglomerating agent, since deactivation of PAC through changes in the pH of a reaction solution may be difficult in the freezing process and washing of the agglomerating agent may be difficult during a washing and drying process, it may adversely affect charging of toner.

In Japanese Patent Application Laid-Open Publication No. 11-311877, a salt of a polyvalent metal ion is used as an agglomerating agent during the preparation of toner by using an emulsion aggregation method. In this case, when an amount of the inorganic salt remaining in toner particles is greater than 1 wt %, fixing properties may be poor because melt viscosity at the time of fixation of the toner is significantly increased, and secondary aggregation may occur during washing because removal of the inorganic salt during the washing is difficult.

In the case that a polyester resin is used as a binder resin, it is also known that physical properties of toner to be obtained may be improved by controlling physical properties of the polyester resin used.

### DETAILED DESCRIPTION OF THE INVENTION

### Technical Problem

The present invention provides a method of preparing toner having good gloss, and a wide fixing temperature range, and providing an excellent image quality by using a polyester resin as a binder resin.

### Technical Solution

According to an aspect of the present invention, there is provided a method of preparing toner including:

mixing a polyester resin dispersion, a colorant dispersion, and a wax dispersion;

aggregating toner particles by adding a agglomerating agent to the mixed solution; and

fusing the aggregated toner particles,

wherein the polyester resin has a number-average molecular weight ranging from about 4,000 to about 7,000, a weight-average molecular weight ranging from about 18,000 to about 30,000, a peak molecular weight (Mp) ranging from about 4,000 to about 10,000, a polydispersity index (PDI) ranging from about 2 to about 5, and an acid value ranging from about 10 mg KOH/g to about 14 mg KOH/g.

According to an embodiment of the present invention, an inorganic base of monovalent metal may be used as a dispersion stabilizer added to the polyester resin dispersion and an inorganic salt of monovalent metal may be used as an agglomerating agent added in the aggregating.

Hereinafter, an exemplary embodiment of the present invention will be described in detail.

According to an aspect of the present invention, a method of preparing toner includes:

mixing a polyester resin dispersion, a colorant dispersion, and a wax dispersion;

aggregating toner particles by adding a agglomerating agent to the mixed solution; and

fusing the aggregated toner particles, wherein the polyester resin has a number-average molecular weight ranging from about 4,000 to about 7,000, a weight-average molecular weight ranging from about 18,000 to about 30,000, an Mp ranging from about 4,000 to about 10,000, a PDI ranging from about 2 to about 5, and an acid value ranging from about 10 mg KOH/g to about 14 mg KOH/g.

The method of preparing toner may further include washing and drying the fused toner particles.

In order to describe the method of preparing toner in more detail, the method is described below by being broadly divided into (A) dispersion preparation process, (B) aggregation process, (C) freezing and fusing process, and (D) washing and drying process.

(A) Dispersion Preparation Process

The dispersion preparation process may be categorized into three kinds. That is, the dispersion preparation process includes preparation of a polyester resin dispersion, preparation of a colorant dispersion, and preparation of a wax dispersion.

In the preparation of a polyester resin dispersion, a polar solvent containing a surfactant and a dispersion stabilizer is mixed with an organic solvent immiscible with the polar solvent to prepare a solvent emulsion, and a polyester resin in a solid phase is then introduced to prepare a polyester dispersion. In an embodiment of the present invention, since the polyester resin is dispersed by being introduced into the polar solvent containing a dispersion stabilizer, a stable dispersion may be prepared. At this time, ends of the polyester resin are ionized by the dispersion stabilizer to thus obtain a stable state of dispersion.

The polar solvent may be water, methanol, ethanol, butanol, acetonitrile, acetone, ethyl acetate, or the like, and for example, water may be used.

The polyester resin used in an embodiment of the present invention has a number-average molecular weight ranging from about 4,000 to about 7,000, a weight-average molecular weight ranging from about 18,000 to about 30,000, an Mp ranging from about 4,000 to about 10,000, a PDI ranging from about 2 to about 5, and an acid value ranging from about 10 mg KOH/g to about 14 mg KOH/g. When the number-average molecular weight, the weight-average molecular weight, the Mp, the PDI, and the acid value all satisfy the foregoing ranges, toner thus obtained may have good gloss and preservability, a wide fixing temperature range, and excellent image quality.

In an embodiment of the present invention, the acronym “Mp” in gel permeation chromatography (GPC) denotes a molecular weight calculated from a peak value of an elution curve obtained by a GPC measurement. GPC measurement conditions are as follows:

Apparatus: Toyo Soda Manufacturing Co., Ltd., HLC8020

Column: Toyo Soda Manufacturing Co., Ltd., TSKgelGMHXL (column size: 7.8 mm (ID)×30.0 cm (L)), three columns linked in series

Oven temperature: 40° C.

Eluent: tetrahydrofuran (THF)

The Mp was determined by drawing a calibration curve using standard polystyrene from the retention time corresponding to a peak value of an elution curve obtained.

The standard polystyrene samples used for drawing the calibration curve were TSK standard, A-500 (molecular weight: 5.0×10²), A-2500 (molecular weight: 2.74×10³), F-2 (molecular weight: 1.96×10⁴), F-20 (molecular weight: 1.9×10⁵), F-40 (molecular weight: 3.55×10⁵), F-80 (molecular weight: 7.06×10⁵), F-128 (molecular weight: 1.09×10⁶), F-288 (molecular weight: 2.89×10⁶), F-700 (molecular weight: 6.77×10⁶), and F-2000 (molecular weight: 2.0×10⁷), by Toyo Soda Manufacturing Co., Ltd.

Also, the expression “peak value” of the elution curve denotes a point where the elution curve is a maximum, and in the case that there are two or more maximum points, the peak value is the maximum value of the elution curve. The eluent is not particularly limited and any solvent that dissolves the polyester resin, such as chloroform, may be used in addition to THF.

An inorganic base of monovalent metal may be used as a dispersion stabilizer added to the polyester resin dispersion and an inorganic salt of monovalent metal may be used as a agglomerating agent added in the aggregating.

The inorganic base of monovalent metal used as the dispersion stabilizer may be NaOH, LiOH, KOH, or the like.

The polyester resin may be prepared by polycondensation of an acid component and an alcohol component. Polyvalent carboxylic acid is mainly used as the acid component and polyhydric alcohols are mainly used as the alcohol component to prepare the polyester resin.

Examples of the polyhydric alcohol component may be polyoxyethylene-(2,0)-2,2-bis(4-hydroxyphenyl)propane, polyoxypropylene-(2,0)-2,2-bis(4-hydroxyphenyl)propane, polyoxypropylene(2,2)-polyoxyethylene-(2,0)-2,2-bis(4-hydroxyphenyl)propane, polyoxyethylene-(2,3)-2,2-bis(4-hydroxyphenyl)propane, polyoxypropylene-(6)-2,2-bis(4-hydroxyphenyl)propane, polyoxypropylene-(2,3)-2,2-bis(4-hydroxyphenyl)propane, polyoxypropylene-(2,4)-2,2-bis(4-hydroxyphenyl)propane, polyoxypropylene-(3,3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, glycerol, and polyoxypropylene. Specifically, the polyvalent carboxylic acid component includes aromatic polyvalent acid and/or an alkyl ester thereof, which are typically used in the preparation of a polyester resin. The aromatic polyvalent acid may be terephthalic acid, isophthalic acid, trimellitic acid, pyromellitic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,2,7,8-octanetetracarboxylic acid, and/or an alkyl ester of these carboxylic acids, and at this time, the alkyl group may be methyl, ethyl, propyl, butyl, or the like. The aromatic polyvalent acid and/or the alkyl ester thereof may be used alone or in combination of two or more. The polyester resin may be a sulfonic acid group-free polyester resin.

Also, a glass transition temperature (Tg) of the polyester resin may be in a range of about 40° C. to about 80° C., and for example, may be in a range of about 50° C. to about 75° C. In the case that the Tg is less than about 40° C., a toner formed by using polyester resin particles may have limitations in preservation stability. In contrast, in the case that the Tg is greater than about 80° C., an offset may easily occur and in particular, during color printing, offset-related problems may be more serious.

Examples of the organic solvent used in the polyester resin dispersion may be at least one selected from the group consisting of dimethyl ether, diethyl ether, 1,1-dichloroethane, 1,2-dichloroethane, dichloromethane, and chloroform. However, the organic solvent is not limited thereto.

An amount of the surfactant used in the polyester resin dispersion may be in a range of about 1 part by weight to about 4 parts by weight based on 100 parts by weight of the polyester resin, an amount of the organic solvent may be in a range of about 15 parts by weight to about 200 parts by weight based on 100 parts by weight of the polyester resin, and an amount of the dispersion stabilizer may be in a range of about 2 equivalent weights to about 3 equivalent weights based on the acid value of the polyester resin.

The colorant dispersion may be prepared by dispersing a colorant in water using a dispersant such as a surfactant, or dispersing a colorant using an organic solvent. In the case of dispersing the colorant in water, an anionic surfactant and a nonionic surfactant may be used as the dispersant, and for example, the anionic surfactant may be used. Since dispersion of a pigment in water may be facilitated by using the dispersant and a dispersion particle size of the pigment in the toner may be reduced, a toner having excellent characteristics may be prepared. The unnecessary dispersant may be removed by a subsequent washing process.

In the case that the colorant is dispersed by using the organic solvent, a dispersion is prepared by using a master batch in which a pigment and a polyester resin are kneaded. Specifically, the master batch and the organic solvent are put in a ball mill and milling is performed for about 24 hours, and then a master batch pigment dispersion may be obtained by adding the mixed solution to water containing a surfactant and a dispersion stabilizer. Also, the colorant may be dispersed by using the same method as the method of preparing the polyester resin dispersion. A dispersion stabilizer used at this time may be the dispersion stabilizer, such as NaOH, used in the preparation of the polyester resin dispersion.

When the master batch pigment dispersion is used, color expression characteristics after the preparation of the toner may be excellent in comparison to the case of using a pigment dispersion.

The colorant used may be appropriately selected from commercially available pigments, such as a black pigment, a cyan pigment, a magenta pigment, a yellow pigment, and a mixture thereof.

An amount of the colorant may be determined to such an amount that the toner has sufficient color reproducibility and forms a visible image by development. For example, the content of the colorant may be in a range of about 3 parts by weight to about 15 parts by weight based on 100 parts by weight of the polyester resin. In the case that the content thereof is less than about 3 parts by weight, a coloring effect may be insufficient. In the case that the content thereof is greater than about 15 parts by weight, a sufficient friction charging amount may not be obtained due to a decrease in electrical resistance of the toner and thus, contamination may occur.

The wax dispersion may be prepared by dispersing a natural or synthetic wax in water or an organic solvent.

A known wax may be used as the wax. Examples of the wax may be a natural wax such as a carnauba wax and a rice wax, a synthetic wax such as a polypropylene wax and a polyethylene wax, a petroleum-based wax such as a montan wax, an alcohol-based wax, and an ester-based wax. The wax may be used alone or in combination of two or more.

In the case that the wax is dispersed in water, a dispersion is obtained by dispersing the wax using a surfactant or a dispersion stabilizer and using a dispersing device such as a high-pressure or high-speed homogenizer. In the case that the wax is dispersed in an organic solvent, the same method as the method of preparing the polyester resin dispersion may be used. That is, an organic solvent is added to water containing a surfactant and a dispersion stabilizer to prepare a solvent emulsion, and a wax in a solid phase is then added to prepare a dispersion. An amount of the wax may be in a range of about 0.5 parts by weight to about 20 parts by weight and for example, may be in a range of about 1 part by weight to about 10 parts by weight, based on 100 parts by weight of the polyester resin.

(B) Aggregation Process

Each dispersion prepared in the dispersion preparation process is mixed, and a agglomerating agent and acid are then added while stirring to aggregate toner particles. The aggregation process may be performed at room temperature, but heating may be performed near the Tg of the polyester resin. Agglomerates having particles with a uniform particle size and shape may be formed by mixing the mixed solution of each dispersion by mechanical shear force through using a stirrer.

The inorganic salt of monovalent metal used as an agglomerating agent may be NaCl or KCl.

An amount of the agglomerating agent used is in a range of about 4.5 wt % to about 5.7 wt % based on a total solid content weight in a reaction solution of the aggregation process. In the case that the amount of the agglomerating agent used is less than about 4.5 wt %, aggregation may not occur, and in the case that the amount of the agglomerating agent used is greater than about 5.7 wt %, a size of aggregated particles may be significantly increased.

A pH of the mixed solution may be adjusted by adding an acid in the aggregation process and for example, the pH thereof may be in a range of about 4.5 to about 6.5.

The aggregation process may be performed at a temperature ranging from about 40° C. to about 60° C. by stirring the reaction solution at a speed ranging from about 1.0 m/sec to about 7.0 m/sec.

In an embodiment of the present invention, the inorganic salt of monovalent metal is used as a agglomerating agent such that monovalent metal ion derived from the inorganic base of monovalent metal used as the dispersion stabilizer during the preparation of the polyester resin dispersion may play a secondary role as the agglomerating agent, and thus, an excellent aggregation effect may be obtained even in the case that a small amount of the agglomerating agent is used.

(C) Freezing and Fusing Process

In order to perform a freezing process, a pH of the reaction solution is increased to about 10 while the temperature of the reaction solution is maintained.

At this time, an inorganic base, such as NaOH, KOH, or LiOH, is added in order to increase the pH.

Thereafter, the mixed solution containing toner particles is heated to make the particle size and shape of the aggregated toner particles uniform. The mixed solution is heated to a temperature above the Tg of the polyester resin to control a particle size to be in a range of about 1 μm to about 20 μm, and as a result, toner particles having nearly a uniform particle size and shape may be obtained.

Surface properties of the particles may be improved by heating to a temperature above the Tg of the polyester resin. Before the heating to a temperature above the Tg of the polyester resin, a polyester resin dispersion or a polystyrene butyl acrylate latex may be added to surround the toner particles generated in the aggregation process and thus, leaking of the pigment or the wax to the outside of the toner particles may be prevented and the toner may be hardened. At this time, a resin dispersion having the same physical properties (Tg, molecular weight) as those of the polyester resin dispersion used in the previous process may be used as the additionally added polyester resin dispersion or polystyrene butyl acrylate latex, and a resin dispersion having a higher Tg and molecular weight may be used. In the case that the resin dispersion having a higher Tg and molecular weight is used, the Tg may be in a range of about 60° C. to about 85° C. and the molecular weight may be in a range of about 10,000 to about 300,000. A particle size may be increased during the surrounding of the toner particles generated in the aggregation process with the additionally added resin dispersion, and in order to prevent this, a fusing process may be performed by adding a surfactant or adjusting pH, and heating to a temperature above the Tg of the polyester resin.

(D) Washing and Drying Process

This is a process of washing the toner particles obtained in the fusing process with water and drying the toner particles. In the process, the mixed solution containing a toner is cooled to room temperature, the mixed solution is filtered, a filtrate is removed, and the toner is cleaned with water. Pure water having a conductivity of about 10 μS/cm or less may be used for the washing and the toner may be cleaned until the conductivity of the filtrate used for washing the toner becomes about 50 μS/cm or less. The washing of the toner using pure water may be performed by using a batch-type or continuous-type method. The washing of the toner using pure water is performed to remove unnecessary components, such as impurities that may affect chargeability of the toner and an unnecessary agglomerating agent that did not participate in the aggregation, other than toner components.

In the case that the inorganic salt of monovalent metal is used as the agglomerating agent, since reagglomeration of the toner particles may not occur due to the reactivation of the inorganic salt according to the changes in the pH during the washing process and the solubility of the inorganic salt of monovalent metal with respect to water is relatively high in comparison to that of an inorganic salt of multivalent metal, the removal of the inorganic salt during the washing may be facilitated. As a result, an amount of the inorganic salt remaining in the toner may be significantly decreased. Therefore, a melt viscosity of the toner particles may not be increased and better fixing properties may be obtained.

The toner obtained after the washing process is dried by using a fluidized bed dryer, a flash jet dryer, or the like.

Also, external additives may be added to the toner obtained by drying.

### Advantageous Effects

According to a preparation method of the present invention, a toner having good gloss and preservability, and a wide fixing temperature range, and providing excellent image quality may be provided.

### BEST MODE

Hereinafter, the present invention will be described in more detail, according to the following examples. However, the present invention is not limited thereto.

### Preparation Example 1

### Synthesis of Polyester Resin (1)

A 3 L reactor equipped with a stirrer, a nitrogen gas inlet, a thermometer, and a cooler was installed in an oil bath, a heating medium. 45 g of terephthalic acid, 39 g of isophthalic acid, 75 g of 1,2-propylene glycol, and 3 g of trimellitic acid were added and dibutyltin oxide as a catalyst was added in an amount of 500 ppm based on a total weight of a monomer. A temperature of the reactor was increased to 150° C. while stirring was performed at 150 rpm. A reaction was performed for 6 hours and the temperature was increased to 220° C., the reactor was depressurized to 0.1 torr to remove byproducts, and the reaction was performed for 15 hours under the same pressure condition to obtain a polyester resin (1).

### Preparation Example 2

### Synthesis of Polyester Resin (2)

137 g of dimethyl terephthalate, 55 g of dimethyl isophthalate, 68 g of ethylene glycol, 175 g of an ethylene oxide adduct of bisphenol A, and 0.1 g of tetrabutoxy titanate as a catalyst were introduced into an autoclave equipped with a thermometer and a stirrer and heated to a temperature ranging from about 150° C. to about 220° C. for 180 minutes to perform a transesterification. Subsequently, the temperature was increased to 240° C., the pressure in the autoclave was gradually decreased to 10 mmHg for 30 minutes, and the reaction was continuously performed for 70 minutes. Nitrogen gas was purged into the autoclave and the pressure was increased to atmospheric pressure. Then, the temperature was decreased to 200° C., 2.0 g of trimellitic acid was added, and a polyester resin (2) was obtained by performing a reaction for 70 minutes.

### Preparation Example 3

### Synthesis of Polyester Resin (3)

215 g of terephthalic acid, 485 g of isophthalic acid, 468 g of 2,2-dimethyl-1,3-propanediol, 156 g of 1.5-pentanediol, and 0.41 g of tetrabutyl titanate as a catalyst were introduced into a reaction vessel equipped with a stirrer, a condenser, and a thermometer, and heated to a temperature ranging from about 160° C. to about 230° C. for 4 hours to perform esterification. The pressure was gradually decreased to 5 mmHg for 20 minutes and a polycondensation reaction was performed at 260° C. for 40 minutes under a vacuum of 0.3 mmHg or less. Cooling was performed to a temperature of 220° C. in a nitrogen gas flow, 23 g of trimellitic acid was added, and a polyester resin (3) was obtained by performing a reaction for 30 minutes.

### Preparation Example 4

### Synthesis of Polyester Resin (4)

38 g of 1,5-naphthalene dicarboxylic acid methyl ester, 96 g of dimethyl terephthalate, 58 g of dimethyl isophthalate, 136 g of ethylene glycol, and 0.1 g of tetrabutoxy titanate as a catalyst were introduced into an autoclave equipped with a thermometer and a stirrer, and heated to a temperature ranging from about 150° C. to about 220° C. for 180 minutes to perform a transesterification. Subsequently, the temperature was increased to 240° C., the pressure in the autoclave was gradually decreased to 10 mmHg for 30 minutes, and the reaction was continuously performed for 70 minutes. Nitrogen gas was purged into the autoclave and the pressure was increased to atmospheric pressure. Then, the temperature was decreased to 200° C. to obtain a polyester resin (4).

### Preparation Example 5

### Synthesis of Polyester Resin (5)

A 3 L reactor equipped with a stirrer, a thermometer, a condenser, and a nitrogen gas inlet was installed in an oil bath. 97 g of dimethyl terephthalate, 96 g of dimethyl isophthalate, 0.15 g of dimethyl 5-sulfoisophthalate sodium salt, 175 g of 1,2-propylene glycol, and 4.0 g of trimellitic acid were respectively added in the reactor. Subsequently, tetrabutyl titanate as a catalyst was added in an amount of 500 ppm based on a total weight of a monomer. Subsequently, a temperature of the reactor was increased to 150° C. while a stirring speed in the reactor was maintained at 100 rpm. Thereafter, a reaction was performed for 5 hours. When methanol, a byproduct of the esterification, was no longer obtained in the condenser, the reaction temperature was again increased to 220° C. The pressure of the reactor was then decreased to 0.1 torr and the reaction was additionally performed for 15 hours to obtain a polyester resin (5).

### Preparation Example 6

### Synthesis of Polyester Resin (6)

140 g of dimethyl terephthalate, 55 g of dimethyl isophthalate, 68 g of ethylene glycol, 175 g of an ethylene oxide adduct of bisphenol A, and 0.2 g of tetrabutoxy titanate as a catalyst were introduced into an autoclave equipped with a thermometer and a stirrer, and heated to a temperature ranging from about 150° C. to about 220° C. for 210 minutes to perform a transesterification reaction. Subsequently, the temperature was increased to 240° C., the pressure in the autoclave was gradually decreased to 10 mmHg for 30 minutes, and the reaction was continuously performed for 90 minutes. Nitrogen gas was purged into the autoclave and the pressure was increased to atmospheric pressure. Then, the temperature was decreased to 200° C., 3.0 g of trimellitic acid was added, and a polyester resin (6) was obtained by performing a reaction for 100 minutes.

Acid Value Measurement

The resin was dissolved in dichloromethane and cooled, and an acid value (mg KOH/g) was then measured by titrating with a 0.1N KOH methyl alcohol solution.

Weight-Average Molecular Weight, Number-Average Molecular Weight, and Mp Measurements

A weight-average molecular weight of the binder resin was measured by GPC using a calibration curve obtained using a polystyrene standard sample.

An Mp was determined by standard polystyrene conversion from the retention time corresponding to a peak value of an elution curve obtained by GPC. Also, the expression “peak value” of the elution curve denotes a point where the elution curve is a maximum, and in the case that there are two or more maximum points, the peak value is the maximum value of the elution curve. Furthermore, the expressions “signal intensity I (Mp) of a GPC curve at a position of the Mp” and “signal intensity I (M100000) of the GPC curve at a position of a molecular weight of 100,000” respectively denote a difference between the signal intensity at the position of the Mp and the signal intensity at a baseline, and a difference between the signal intensity at the position of a molecular weight of 100,000 and the signal intensity at a baseline. These signal intensities are represented as potential (mV).

Apparatus: Toyo Soda Manufacturing Co., Ltd., HLC8020

Column: Toyo Soda Manufacturing Co., Ltd., TSKgelGMHXL (column size: 7.8 mm (ID)×30.0 cm (L)), three columns linked in series.

Oven temperature: 40° C.

Eluent: THF

Sample concentration: 4 mg/10 ml

Filtering condition: sample solution was filtered with a 0.45 μm of Teflon (trademark) membrane filter

Flow rate: 1 ml/minute

Injection volume: 0.1 ml

Detector: RI

Standard polystyrene samples for drawing a calibration curve: Toyo Soda Manufacturing Co., Ltd, TSK standard, A-500 (molecular weight: 5.0×10²), A-2500 (molecular weight: 2.74×10³), F-2 (molecular weight: 1.96×10⁴), F-20 (molecular weight: 1.9×10⁵), F-40 (molecular weight: 3.55×10⁵), F-80 (molecular weight: 7.06×10⁵), F-128 (molecular weight: 1.09×10⁶), F-288 (molecular weight: 2.89×10⁶), F-700 (molecular weight: 6.77×10⁶), and F-2000 (molecular weight: 2.0×10).

TABLE 1

| | | | Weight- | Number- | |
|---|---|---|---|---|---|
| | | | average | average | |
| | PDI | Acid value | molecular | molecular | |
| | (Mw/Mn) | (mg KOH/g) | weight | weight | Mp |
| Preparation | 3 | 11 | 18,000 | 6,000 | 8,000, |
| Example 1 | | | | | |
| Preparation | 3.5 | 12 | 24,500 | 7,000 | 8,900 |
| Example 2 | | | | | |
| Preparation | 4 | 11 | 27,600 | 6,900 | 5,500 |
| Example 3 | | | | | |
| Preparation | 5 | 14 | 20,500 | 4,100 | 7,500 |
| Example 4 | | | | | |
| Preparation | 10 | 10 | 35,000 | 3,400 | 11,000 |
| Example 5 | | | | | |
| Preparation | 8 | 13 | 37,500 | 4,800 | 13,500 |
| Example 6 | | | | | |

### Preparation Example 7

### Preparation of Polyester Resin Dispersion (1)

30 ml of a 1N sodium hydroxide solution as a dispersion stabilizer was introduced into a 1 L reactor equipped with a thermometer and an impeller-type stirrer so as to be equivalent to the acid value of the polyester resin (1), and a surfactant (dowfax, Dow Corning Corporation, 1 wt % with respect to the amount of the polyester resin) and 500 ml of water were added. 150 g of methyl ethyl ketone was introduced thereinto and the temperature was increased to 70° C. to prepare a solvent emulsion. The solvent emulsion was dispersed by adding 100 g of the polyester resin (1) in a solid phase thereinto. The pressure was decreased to 0.3 torr at a temperature of 80° C. to remove the organic solvent. Finally, a polyester resin dispersion (1) having a solid content concentration of 17% was obtained. At this time, an average particle size of dispersed particles in the polyester resin dispersion was 0.2 μm. The average particle size was measured by using a Microtrac particle size analyzer (NIKKISO, Japan).

### Preparation Example 8

### Preparation of Polyester Resin Dispersion (2)

A polyester resin dispersion (2) was obtained in the same manner as Preparation Example 7 except that 40 ml of a 1N sodium hydroxide solution as a dispersion stabilizer was used and the polyester resin (2) was used instead of the polyester resin (1). At this time, an average particle size of dispersed particles in the polyester resin dispersion was 0.3 μm.

### Preparation Example 9

### Preparation of Polyester Resin Dispersion (3)

A polyester resin dispersion (3) was obtained in the same manner as Preparation Example 7 except that 50 ml of a 1N sodium hydroxide solution as a dispersion stabilizer was used and the polyester resin (3) was used instead of the polyester resin (1). At this time, an average particle size of dispersed particles in the polyester resin dispersion was 0.3 μm. The average particle size was measured by using a Microtrac particle size analyzer (NIKKISO, Japan).

### Preparation Example 10

### Preparation of Polyester Resin Dispersion (4)

A polyester resin dispersion (4) was obtained in the same manner as Preparation Example 7 except that 40 ml of a 1N sodium hydroxide solution as a dispersion stabilizer was used and the polyester resin (4) was used instead of the polyester resin (1). At this time, an average particle size of dispersed particles in the polyester resin dispersion was 0.5 μm.

### Preparation Example 11

### Preparation of Polyester Resin Dispersion (5)

A polyester resin dispersion (5) was obtained in the same manner as Preparation Example 7 except that 10 ml of a 1N sodium hydroxide solution as a dispersion stabilizer was used and the polyester resin (5) was used instead of the polyester resin (1). At this time, an average particle size of dispersed particles in the polyester resin dispersion was 0.4 μm.

### Preparation Example 12

### Preparation of Polyester Resin Dispersion (6)

A polyester resin dispersion (6) was obtained in the same manner as Preparation Example 7 except that 10 ml of a 1N sodium hydroxide solution as a dispersion stabilizer was used and the polyester resin (6) was used instead of the polyester resin (1). At this time, an average particle size of dispersed particles in the polyester resin dispersion was 0.35 μm.

### Preparation Example 13

### Preparation of Pigment Dispersion

3 kg of a cyan pigment (Dainichiseika Color & Chemicals Mfg. Co., Ltd., ECB-303) was introduced into a 20 L reactor, 11.5 kg of purified water and 0.6 kg of hydroxypropylmethyl cellulose acetate phthalate (Samsung Fine Chemicals Co. Ltd., AnyCoat-P) were further added to the reactor, and stirring was performed at a speed of 50 rpm. Subsequently, the content in the reactor was transferred to a ball mill type reactor to perform preliminary dispersion. As a result of the preliminary dispersion, dispersed cyan pigment particles having a volume-average particle size (D50(v)) of 3.4 μm (measured by using a Coulter Multisizer by Beckman Coulter, Inc.) were obtained. Thereafter, high dispersion of the content in the reactor was performed at a pressure of 1,500 bar by using an Ultimaizer system (Amstec Ltd., Model HJP25030). As a result of the high dispersion, dispersed nanosized cyan pigment particles having a D50(v) of 150 nm (measured by using a Microtrac 252 by Microtrac, Inc.) were obtained.

### Preparation Example 14

### Preparation of Wax Dispersion

50 g of a paraffin wax (NIPPON SEIRO, HNP10, melting point 72° C.), 10 g of an anionic surfactant (dowfax, Dow Corning Corporation), and 160 g of ion-exchanged water were introduced into a jacket part and dispersion is performed for 30 minutes while a homogenizer (IKA) is heated to 95° C. Then, a dispersed mixture was transferred to a pressure discharge type homogenizer (Nippon Precision Machine Mfg. Co., Ltd.) and a dispersion treatment was performed at 90° C. for 20 minutes to obtain dispersed nanosized wax dispersion having a D50(v) of 230 nm (measured by using a Microtrac 252 by Microtrac, Inc.).

### Example 1

A mixed solution was obtained by mixing the polyester resin dispersion (1), the pigment dispersion, and the wax dispersion at a solid content concentration presented in Table 2 below. At this time, pure water was added to control a total solid content concentration to be 13 wt %. 53 g of a 10% sodium chloride aqueous solution and 10 g of a 0.3 M nitric acid aqueous solution were added to the mixed solution and stirred at 10,000 rpm by using a blend type stirrer, and the temperature was increased to 55° C. Aggregation was performed under stirring for 3 hours, and the pH was then adjusted to 10 and the temperature was increased to 96° C. to fuse toner particles. When the temperature was decreased to 60° C., a 1N sodium hydroxide solution was added to adjust the pH to 9. Coarse particles were sieved through a mesh (opening size 20 μm) and agglomerates were cleaned three times with water, and a 0.3 M nitric acid aqueous solution was then added to adjust the pH to 1.5. Thereafter, the agglomerates were washed three times with pure water and then filtered. A filtrate was dried with a fluidized bed dryer to prepare a cyan toner.

### Examples 2 to 4

Each mixed solution was obtained by mixing each of the polyester resin dispersions (2) to (4), the pigment dispersion, and the wax dispersion at a composition and a solid content concentration presented in Table 2 below. Thereafter, each toner was prepared in the same manner as Example 1 to prepare each cyan toner.

### Comparative Example 1

A mixed solution was obtained by mixing the polyester resin dispersion (5), the pigment dispersion, and the wax dispersion at a composition and a solid content concentration presented in Table 2 below. Thereafter, a toner was prepared in the same manner as Example 1 to prepare a cyan toner.

### Comparative Example 2

A mixed solution was obtained by mixing the polyester resin dispersion (6), the pigment dispersion, and the wax dispersion at a composition and a solid content concentration presented in Table 2 below. Thereafter, pure water was added to control a total solid content concentration to be 13 wt %. 4.2 g of a 10% polyaluminum chloride (PAC) solution and 10 g of a 0.3 M nitric acid aqueous solution were added to the mixed solution and stirred at 10,000 rpm by using a blend type stirrer, and the temperature was increased to 55° C. Aggregation was performed under stirring for 3 hours. Thereafter, 1N NaOH was added to adjust a pH to 10 and 12 g of ethylenediaminetetraacetic acid (EDTA) was added to deactivate a polyvalent metal salt, and the temperature was then increased to 96° C. to fuse toner particles. When the temperature was decreased to 60° C., a 1N sodium hydroxide solution was added to adjust the pH to 9. Coarse particles were sieved through a mesh (opening size 20 μm) and agglomerates were cleaned three times with water, and a 0.3 M nitric acid aqueous solution was then added to adjust the pH to 1.5. Thereafter, the agglomerates were washed three times with pure water and then filtered. A filtrate was dried with a fluidized bed dryer to prepare a black toner.

In Table 2 below, the amounts of the polyester resin dispersion, the wax dispersion, and the pigment dispersion were represented as wt % based on a solid content. An amount of the agglomerating agent was represented as wt % based on a total solid content in the aggregated reaction solution.

TABLE 2

| | | | | | | Comparative | Comparative |
|---|---|---|---|---|---|---|---|
| | | Example 1 | Example 2 | Example 3 | Example 4 | Example 1 | Example 2 |
| Polyester | Polyester | 3 | 3.5 | 4 | 5 | 10 | 8 |
| resin | resin PDI | | | | | | |
| | (Mw/Mn) | | | | | | |
| | NaOH | 30 ml | 40 ml | 50 ml | 40 ml | 30 ml | 30 ml |
| | input | | | | | | |
| Agglomerating | NaCl | 5.175% | 5.175% | 5.175% | 5.175% | 5.175% | |
| agent | PAC | | | | | | 0.42% |
| | Resin | 89.6 | 89.6 | 89.6 | 89.6 | 89.6 | 89.6 |
| | dispersion | | | | | | |
| | Pigment | 5.2 | 5.2 | 5.2 | 5.2 | 5.2 | 5.2 |
| | dispersion | | | | | | |
| | Wax | 5.2 | 5.2 | 5.2 | 5.2 | 5.2 | 5.2 |
| | dispersion | | | | | | |

In Table 2 above, the amounts of the resin dispersion, the pigment dispersion, and the wax dispersion were represented as wt % based on a solid content.

Evaluations of average particle size, circularity, image, gloss, and preservability were performed for the toner particles prepared in Examples 1 to 4 and Comparative Examples 1 and 2, and the results thereof are presented in Table 3 below.

(Average Particle Size)

Average particle sizes of toner particles were measured by using a Coulter Multisizer III (Beckman Coulter, Inc., USA), and the number of particles counted was 50,000 and a size of an aperture used was 100 μm.

(Image Evaluation)

Image evaluation was performed by developing with an apparatus prepared by remodeling CP 2025 (HP), a digital full color printer. The image density was measured by using a SpectroEye (GretagMacbeth Company), a spectrophotometer.

ok: 1.3 or more of image density

ng: less than 1.3 of image density

(Gloss Evaluation)

Gloss evaluation was performed by developing with an apparatus prepared by remodeling CP 2025 (HP), a digital full color printer. Gloss was measured by using a gloss meter (Gretag Macbeth, Company).

ok: 13 or more of gloss

ng: less than 13 of gloss

(Fixing Temperature)

Toner prepared by mixing 9.75 g of the prepared toner particles, 0.2 g of silica (Cabot Corporation, TG 810G), and 0.05 g of silica (Degussa GmbH, RX50) were used to obtain unfixed images having a solid image size of 30 mm×40 mm through a Samsung CLP-510 printer. Thereafter, the fixability of the unfixed images was evaluated while a temperature of a fixing roller was changed in a fixing tester which was converted so as to randomly change a fixing temperature. Temperature ranges were marked, in which cold offset or hot offset does not occur, and the results of the evaluation are presented in Table 3 below.

(Residual Amount of Metal in Toner)

Inductively coupled plasma (ICP) analysis was performed for the prepared toners to measure the amounts of inorganic metals remaining in the toners.

TABLE 3

| | Average | | | | | Fixing | Residual |
|---|---|---|---|---|---|---|---|
| | particle | Image | | | | temperature | metal amount |
| | size (μm) | density | | Gloss | | range | in toner |
| Example 1 | 6.5 | 1.4 | ok | 16 | ok | 120-180° C. | 525 ppm |
| Example 2 | 5.8 | 1.3 | ok | 14 | ok | 130-190° C. | 650 ppm |
| Example 3 | 11 | 1.3 | ok | 13 | ok | 120-180° C. | 802 ppm |
| Example 4 | 6.4 | 1.3 | ok | 13 | ok | 120-190° C. | 625 ppm |
| Compara- | 13 | 1.1 | ng | 10 | ng | 140-180° C. | 1050 ppm |
| tive | | | | | | | |
| Example 1 | | | | | | | |
| Compara- | 7.0 | 0.9 | ng | 5 | ng | 160-200° C. | 3075 ppm |
| tive | | | | | | | |
| Example 2 | | | | | | | |

As illustrated in Table 3 above, it may be understood that the toner particles prepared according to the preparation method of an embodiment of the present invention had a narrow particle size distribution, and excellent gloss and image quality. Also, it may be confirmed that the amounts of metals remaining in the toners were significantly reduced.

While the present invention has been particularly shown and described with reference to exemplary embodiments thereof, it will be understood by those of ordinary skill in the art that various changes in form and details may be made therein without departing from the spirit and scope of the present invention as defined by the following claims. Hence, the protective scope of the present invention shall be determined by the accompanying claims.

What is claimed is:

1. A method of preparing toner, the method comprising:
mixing a polyester resin dispersion, a colorant dispersion, and a wax dispersion;
aggregating toner particles by adding a agglomerating agent to the mixed solution; and
fusing the aggregated toner particles,
wherein the polyester resin has a number-average molecular weight ranging from about 4,000 to about 7,000, a weight-average molecular weight ranging from about 18,000 to about 30,000, a peak molecular weight (Mp) ranging from about 4,000 to about 10,000, a polydispersity index (PDI) ranging from about 2 to about 5, and an acid value ranging from about 10 mg KOH/g to about 14 mg KOH/g.

2. The method of claim 1, wherein an inorganic base of monovalent metal is used as a dispersion stabilizer added to the polyester resin dispersion and an inorganic salt of monovalent metal is used as an agglomerating agent added in the aggregating.

3. The method of claim 2, wherein the dispersion stabilizer is NaOH, LiOH, or KOH.

4. The method of claim 2, wherein the agglomerating agent is NaCl or KCl.

5. The method of claim 1, wherein an amount of the agglomerating agent is in a range of about 4.5 wt % to about 5.7 wt % based on a total solid content weight in a reaction solution of the aggregating.

6. The method of claim 1, further comprising washing and drying the toner particles after the fusing.

7. The method of claim 1, wherein the polyester resin dispersion is prepared by using a method comprising:
stirring a mixture of a dispersion stabilizer, a surfactant, a polar solvent, and an organic solvent immiscible with the polar solvent to prepare a solvent emulsion; and
adding a polyester resin to the solvent emulsion.

8. The method of claim 7, wherein the polar solvent is water.

9. The method of claim 7, wherein the organic solvent is at least one selected from the group consisting of dimethyl ether, diethyl ether, 1,1-dichloroethane, 1,2-dichloroethane, dichloromethane, and chloroform.
